(19) United States
(12) Patent Application Publication
(10) Pub. No.: US 2025/0192400 A1
(43) Pub. Date: Jun. 12, 2025

(54) BATTERY PACK

(71) Applicants: HYUNDAI MOTOR COMPANY, Seoul (KR); KIA CORPORATION, Seoul (KR)

(72) Inventors: Su In Park, Hwaseong-si (KR); Se Gi Kang, Hwaseong-si (KR); Beom Sik Park, Hwaseong-si (KR)

(73) Assignees: HYUNDAI MOTOR COMPANY, Seoul (KR); KIA CORPORATION, Seoul (KR)

(21) Appl. No.: 18/974,368

(22) Filed: Dec. 9, 2024

(30) Foreign Application Priority Data
Dec. 12, 2023 (KR) 10-2023-0180168

(51) Int. Cl. H01M 50/588; H01M 50/204; H01M 50/289; H01M 50/507

(52) U.S. Cl. CPC H01M 50/588; H01M 50/289; H01M 50/507; H01M 50/204

(57) ABSTRACT

A battery pack includes: a first battery module, a second battery module spaced apart from the first battery module in a first direction, a base plate that supports the first battery module and the second battery module, a support member supported by the base plate, and extending in a second direction crossing the first direction in a space between the first battery module and the second battery module, and a busbar extending from an upper side of the support member in the second direction through the space between the first battery module and the second battery module.

### CROSS-REFERENCE TO RELATED APPLICATION

This application claims the benefit of and priority to Korean Patent Application No. 10-2023-0180168, filed in the Korean Intellectual Property Office on Dec. 12, 2023, the entire contents of which are incorporated herein by reference.

### TECHNICAL FIELD

The present disclosure relates to a battery pack.

### BACKGROUND

The statements in this section merely provide background information related to the present disclosure and may not constitute prior art.

In light of the growing awareness regarding environmental crises and the depletion of oil resources, there has been a notable emphasis on research and development aimed at eco-friendly vehicles, particularly electric vehicles. The electric vehicles include plug-in hybrid electric vehicles (PHEVs), battery electric vehicles (BEVs), and fuel cell electric vehicle (FCEVs).

An electric vehicle may include a battery module and a battery pack housing that supports the battery module. Meanwhile, the electric vehicle uses battery cells of the battery module as a power source, and it is necessary to sense a voltage of a plurality of battery modules or supply electric power to the plurality of battery modules.

A battery pack may include a busbar for supplying electric power to the plurality of battery modules. Then, a short circuit may occur between the busbar and the plurality of battery modules due to interference between the busbar and the battery modules.

### SUMMARY

The present disclosure has been made to solve the above-mentioned problems occurring in the prior art while advantages achieved by the prior art are maintained intact.

An aspect of the present disclosure provides a battery pack, in which a busbar is disposed between two adjacent battery modules.

The technical problems to be solved by the present disclosure are not limited to the aforementioned problems, and any other technical problems not mentioned herein should be clearly understood from the following description by those having ordinary skill in the art to which the present disclosure pertains.

According to an aspect of the present disclosure, a battery pack includes: a first battery module, a second battery module spaced apart from the first battery module in a first direction, and a base plate that supports the first battery module and the second battery module. The battery pack further includes: a support member supported by the base plate, and extending in a second direction crossing the first direction in a space between the first battery module and the second battery module; and a busbar extending from an upper side of the support member in the second direction through the space between the first battery module and the second battery module.

The support member may include an opening groove having a shape opened toward an upper side, and the battery pack may further include a busbar frame that supports the busbar and inserted into the opening groove.

The support member may include a pair of side support walls spaced apart from each other in the first direction while the opening groove being interposed therebetween, and extending in the second direction.

The busbar may include a lower busbar including a partial area inserted into the opening groove, and an upper busbar disposed on an upper side of the pair of side support walls.

The busbar frame may include: a lower busbar frame that supports the lower busbar on a lower side of the lower busbar and inserted into the opening groove, and an upper busbar frame disposed between the lower busbar and the upper busbar and that supports the upper busbar.

The lower busbar may include a first lower busbar, and a second lower busbar disposed to be spaced apart from the first lower busbar in the first direction, and the lower busbar frame may include a lower cover wall extending in the second direction to cover outer sides of the first lower busbar and the second lower busbar while the first lower busbar and the second lower busbar being interposed therebetween.

The lower busbar frame may include a lower base wall connecting the pair of lower cover wall, and a lower guide rib protruding upward from the lower base wall.

In one embodiment, a height of the lower guide rib in an upward and downward direction (hereinafter “the upward/downward direction”) may be configured to be smaller than a height of the lower cover wall in the upward/downward direction.

The lower busbar frame may include a lower partition wall extending from the lower base wall toward an upper side to be longer than the lower guide rib.

The lower partition wall may extend in parallel to the pair of lower cover walls.

The upper busbar may include: a first upper busbar, and a second upper busbar disposed to be spaced apart from the first upper busbar in the first direction, and the upper busbar frame may include a pair of upper cover walls covering outer sides of the first upper busbar and the second upper busbar while the first upper busbar and the second upper busbar being interposed therebetween, and supported by the lower cover wall to extend in the second direction.

The upper busbar frame may include: an upper base wall connecting the pair of upper cover walls, and an upper guide rib protruding upward or downward from the upper base wall.

The upper guide rib may include: a first upper guide rib protruding upward from the upper base wall, and a second upper guide rib protruding downward from the upper base wall.

In another embodiment, heights of the first upper guide rib and the second upper guide rib in the upward/downward direction may be configured to be smaller than a height of the upper cover wall in the upward/downward direction.

The upper busbar frame may include an upper partition wall extending from the upper base wall toward an upper side to be longer than the upper guide rib.

The upper partition wall may extend in parallel to the pair of upper cover walls.

In one embodiment, a recess may be formed in each side support wall of the pair of side support walls, and the upper busbar frame may include a hook member seated on each of the side support walls and that is inserted into the recess.

### BRIEF DESCRIPTION OF THE DRAWINGS

The above and other objects, features and advantages of the present disclosure should be more apparent from the following detailed description taken in conjunction with the accompanying drawings:

FIG. 1 is a perspective view of a battery pack according to an embodiment of the present disclosure;

FIG. 2 is a perspective view of a battery pack housing and a battery module according to an embodiment of the present disclosure;

FIG. 3 is a plan view of a battery pack housing and a battery module according to an embodiment of the present disclosure;

FIG. 4 is an exploded view of a longitudinal busbar module and a second longitudinal support member according to an embodiment of the present disclosure;

FIG. 5 is a perspective view of the second longitudinal support member illustrated in FIG. 4;

FIG. 6 is a perspective view of a lower busbar frame illustrated in FIG. 4;

FIG. 7 is a perspective view of an upper busbar frame illustrated in FIG. 4;

FIG. 8 is a vertical cross-sectional view taken along line A-A′ illustrated in FIG. 3;

FIG. 9 is an enlarged view of a state, in which a longitudinal busbar module and a second longitudinal support member are coupled to each other in FIG. 2.

### DETAILED DESCRIPTION

Hereinafter, some embodiments of the present disclosure are described in detail with reference to the attached drawings so that those having ordinary skill in the art may easily implement the present disclosure. When adding reference numerals to components in each drawing, it should be noted that identical components are given the same reference numerals as much as possible even if they are shown in different drawings. Additionally, in describing embodiments of the present disclosure, when it is determined that detailed descriptions of related known configurations or functions may impede understanding of the embodiments of the present disclosure, detailed descriptions thereof are omitted.

Furthermore, in describing the components of the embodiments of the present disclosure, terms, such as first, second, “A”, “B”, (a), and (b) may be used. The terms are simply for distinguishing the components, and the essence, the sequence, and the order of the corresponding components are not limited by the terms. Unless defined differently, all the terms including technical or scientific terms have the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

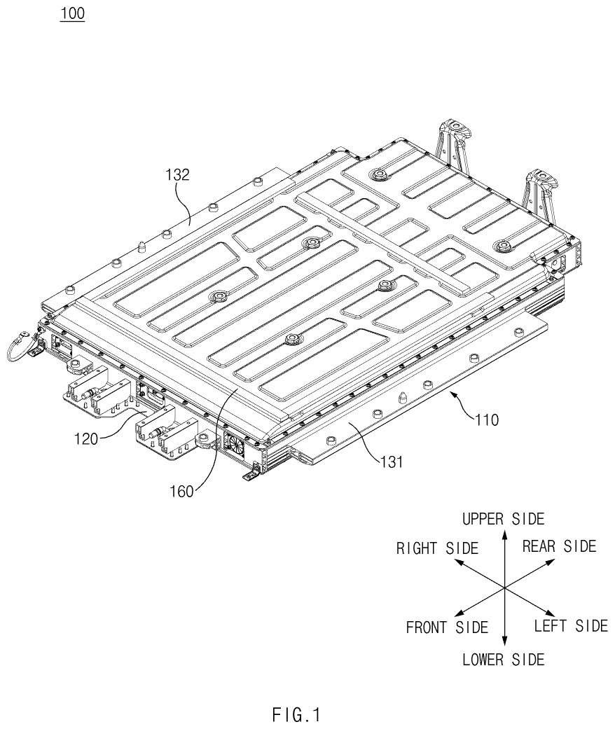

Hereinafter, with reference to FIGS. 1-9, embodiments of the present disclosure are described in detail.

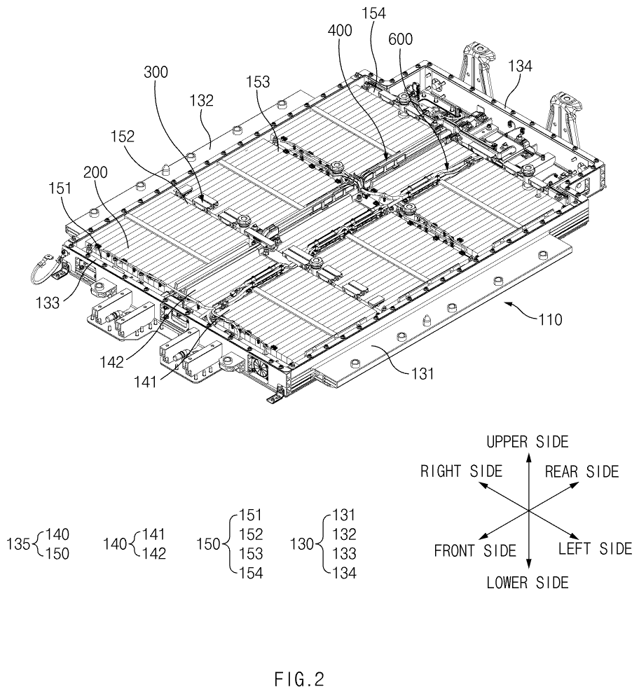

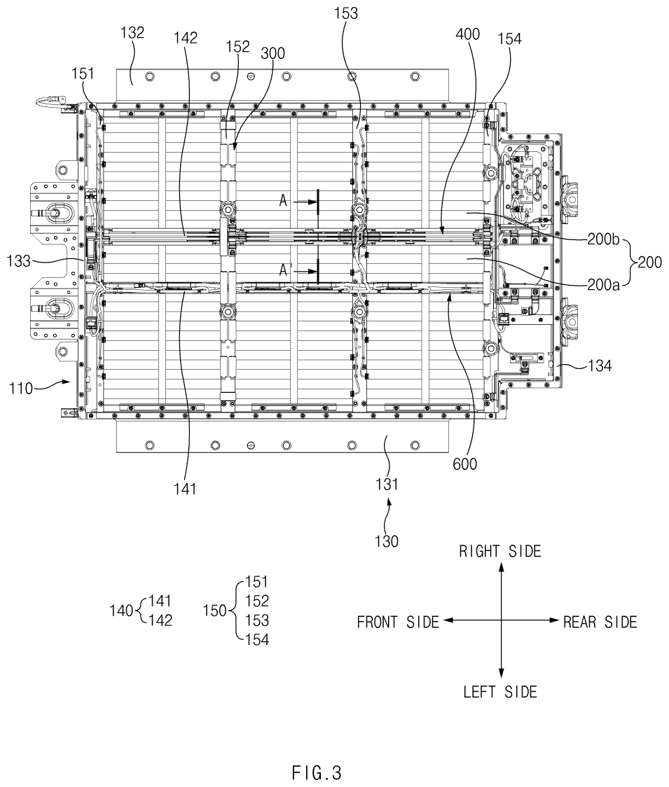

FIG. 1 is a perspective view of a battery pack according to an embodiment of the present disclosure. FIG. 2 is a perspective view of a battery pack housing and a battery module according to an embodiment of the present disclosure. FIG. 3 is a plan view of the battery pack housing and the battery module according to an embodiment of the present disclosure.

Referring to FIGS. 1-3, a battery pack 100 may be a component that is mounted in an interior of an electric vehicle to transmit power to the electric vehicle. The battery pack 100 may include a battery module 200, and a battery pack housing 110 that covers the battery module 200.

The battery module 200 may include a plurality of battery cells (not illustrated). The battery cell may be a lithium-ion battery, but is not limited thereto. The plurality of battery cells may be used in the form of the battery module to be protected from an external shock, heat, vibration, and the like or to provide high electric power. The plurality of battery modules 200 may be supported by the battery pack housing 110 while being spaced apart from each other in a forward/rearward direction or a leftward/rightward direction.

The battery pack housing 110 may include a base plate 120 that is disposed on a lower side of the battery module 200 and supports the battery module 200, and a side member 130 that is supported by the base plate 120 and extends along a circumference of the base plate 120. The battery pack housing 110 may include a pack cover 160 that is coupled to the side member 130 and covers an upper side of the battery module 200.

The base plate 120 may be configured to have a substantially rectangular shape. The side member 130 may be coupled to the base plate 120 along the circumference of the base plate 120 to cover a front side, a rear side, a left side, and a right side of the battery module 200.

The side member 130 may include a first side member 131 that extends in a first direction that faces a front side to cover the left side of the battery module 200, and a second side member 132 that is provided in parallel to the first side member 131 to cover the right side of the battery module 200. The side member 130 may include a third side member 133 that connects the first side member 131 and the second side member 132 and covers the front side of the battery module 200, and a fourth side member 134 that is provided in parallel to the third side member. The fourth side member 134 covers the rear side of the battery module 200 and connects the first side member 131 and the second side member 132.

A support member 135 may be disposed between the first to fourth side members 131, 132, 133, and 134. The support member 135 may be supported by the base plate 120.

The support member 135 may include a longitudinal support member 140 that extends in a long side direction of the base plate 120, and a transverse support member 150 that extends in a short side direction of the base plate 120.

The transverse support member 150 may extend in a first direction (e.g., a leftward/rightward direction). The transverse support member 150 may extend along a transverse direction of the base plate 120.

The transverse support member 150 may include a first transverse support member 151 that is disposed adjacent to the third side member 133, and a second transverse support member 152 that is disposed on a rear side of the first transverse support member 151 and disposed in parallel to the first transverse support member 151. The transverse support member 150 may include a third transverse support member 153 that is disposed on a rear side of the second transverse support member 152 and is disposed in parallel to the second transverse support member 152, and a fourth transverse support member 154 that is disposed in parallel to the first to third transverse support members 151, 152, and 153 on a rear side of the third transverse support member 153 and is provided adjacent to the fourth side member 134.

The longitudinal support member 140 may extend from the first transverse support member 151 toward the fourth transverse support member 154. The longitudinal support member 140 may extend in a longitudinal direction of the base plate 120. In other words, the longitudinal support member 140 may extend in a second direction (e.g., a forward/rearward direction).

The longitudinal support member 140 may include a first longitudinal support member 141 and a second longitudinal support member 142 that are disposed in parallel to each other.

The battery module 200 may be disposed to be divided into first to fourth transverse support members 151, 152, 153, and 154 and first and second longitudinal support members 141 and 142. In other words, the battery module 200 may be divided and arranged by the first to fourth transverse support members (151, 152, 153, 154) and the first and second longitudinal support members (141, 142)

The battery module 200 may include a first battery module 200a and a second battery module 200b that are spaced apart from each other by the first to fourth transverse support members 151, 152, 153, and 154 or are spaced apart from each other by any one of the first and second longitudinal support members 141 and 142.

The first battery module 200a and the second battery module 200b are supported by the base plate 120 and may be spaced apart from each other in a first direction (e.g., the leftward/rightward direction). The second longitudinal support member 142 may be provided between the first battery module 200a and the second battery module 200b.

The second longitudinal support member 142 may be supported by the base plate 120, and may extends in a second direction (e.g., the forward-backward direction) in a space between the first battery module 200a and the second battery module 200b.

A transverse busbar module 300 may be provided on an upper side of the first to fourth transverse support members 151, 152, 153, and 154, and a longitudinal busbar module 400 may be provided on an upper side of the second longitudinal support member 142. A longitudinal cable module 600 may be provided on an upper side of the first longitudinal support member 141.

The longitudinal cable module 600 may connect electric parts (not illustrated) that are provided on a front side of the battery pack housing 110 or electric parts (not illustrated) that are provided in a rear side of the battery pack housing 110. Furthermore, the longitudinal cable module 600 may be a cable for connecting the electric parts and a plurality of battery modules 200 to transmit a voltage that is detected by the plurality of battery modules 200 to the electric parts.

The transverse busbar module 300 is disposed on an upper side of the transverse support member 150 and may electrically connect the plurality of battery modules 200 that are spaced apart from each other in a first direction (e.g., the leftward/rightward direction) that is a transverse direction.

The longitudinal busbar module 400 may be disposed on an upper side of the second longitudinal support member 142 to connect the electric parts (not illustrated) and the plurality of battery modules 200, or electrically connect the plurality of battery modules 200 that are spaced apart from each other in a second direction that is a longitudinal direction.

Meanwhile, the longitudinal busbar module 400 may extend in the second direction (e.g., the forward/rearward direction) through the space between the first battery module 200a and the second battery module 200b that are spaced apart from each other in the first direction on an upper side of the second longitudinal support member 142.

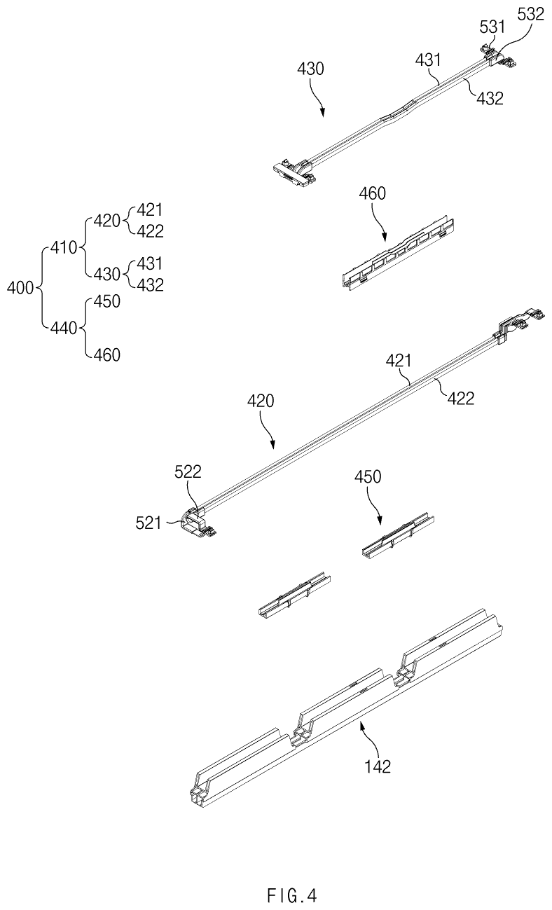

According to the structure, as compared to a structure of a longitudinal busbar module that extends across an upper side of the battery module 200 to connect the plurality of battery modules 200 that are spaced apart from each other in the longitudinal direction, a short circuit that may occur between the battery module 200 and a busbar 410 (see FIG. 4) may be prevented.

Hereinafter, the longitudinal busbar 400 module is described in detail.

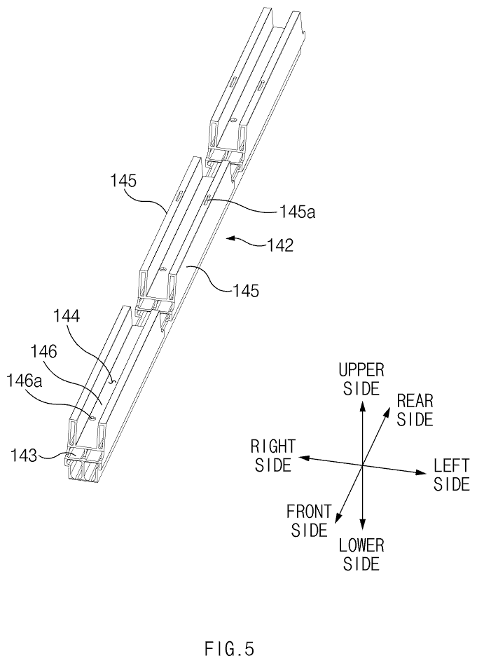

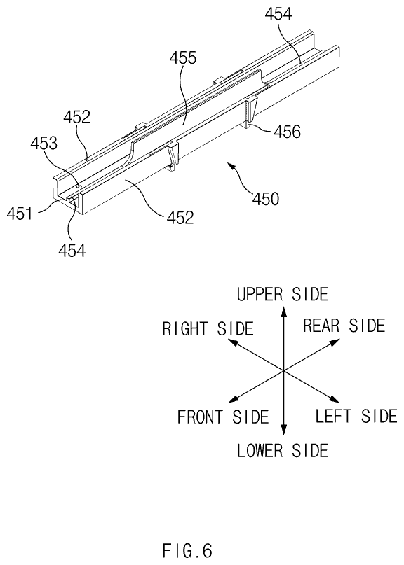

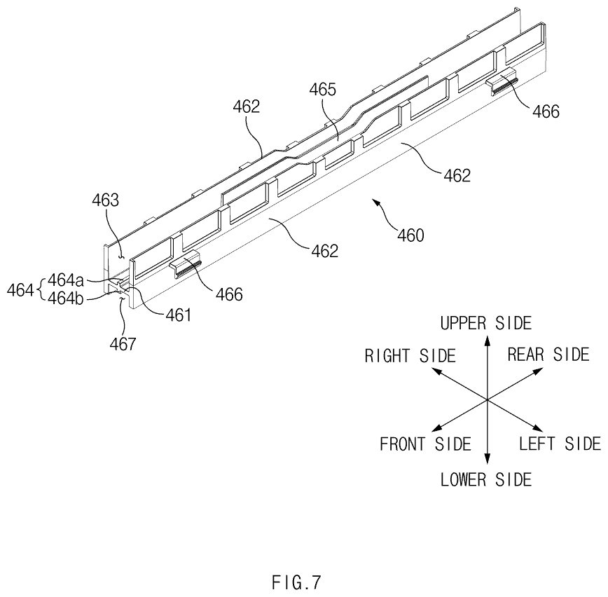

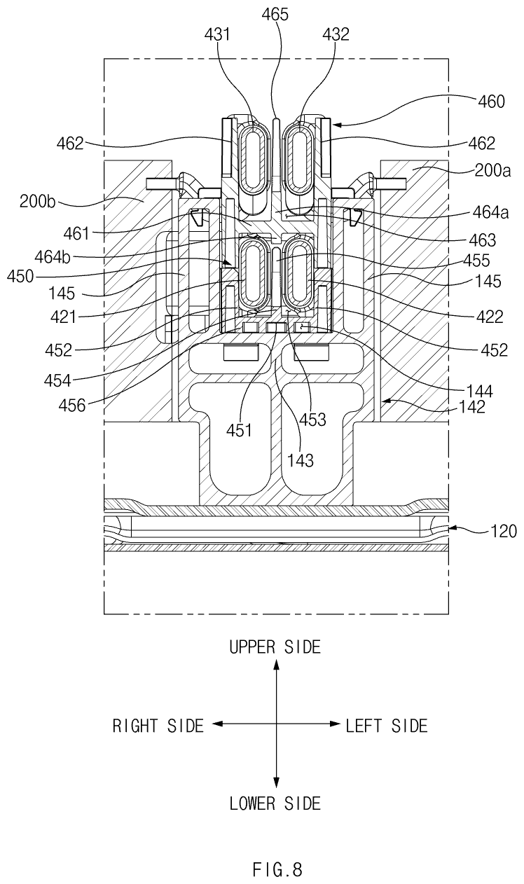

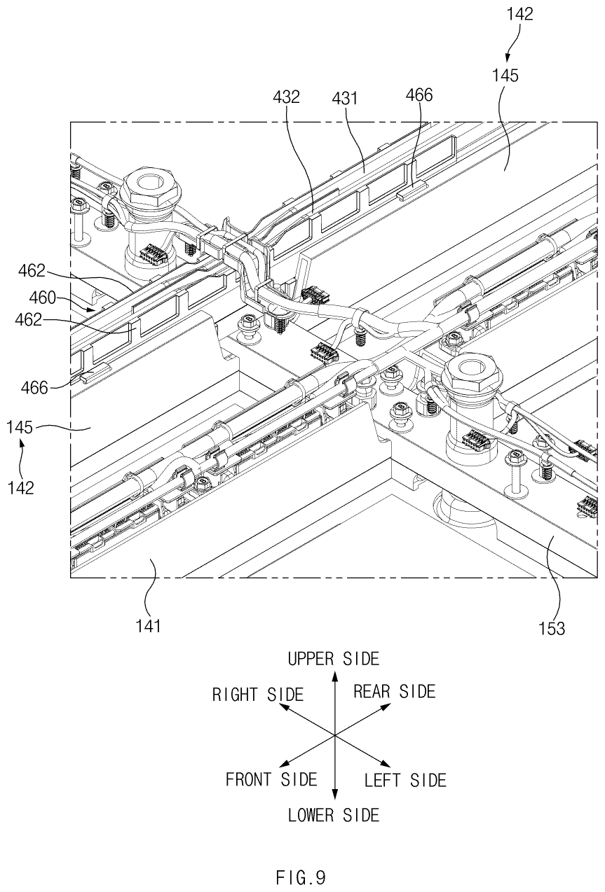

FIG. 4 is an exploded view of the longitudinal busbar module and the second longitudinal support member according to an embodiment of the present disclosure. FIG. 5 is a perspective view of the second longitudinal support member illustrated in FIG. 4. FIG. 6 is a perspective view of a lower busbar frame illustrated in FIG. 4. FIG. 7 is a perspective view of an upper busbar frame illustrated in FIG. 4. FIG. 8 is a vertical cross-sectional view taken along line A-A′ illustrated in FIG. 3. FIG. 9 is an enlarged view of a state, in which the longitudinal busbar module and the second longitudinal support member are coupled to each other in FIG. 2.

Referring to FIGS. 4 to 9, the longitudinal busbar module 400 may include a busbar 410, and a busbar frame 440 that is configured to support the busbar 410.

As illustrated in FIG. 3, the busbar 410 may extend in the second direction (e.g., the forward/rearward direction) through the space between the first battery module 200a and the second battery module 200b on an upper side of the second longitudinal support member 142. The busbar 410 may include a lower busbar 420 and an upper busbar 430 that are spaced apart in upward/downward direction, respectively.

The lower busbar 420 may extend in the second direction (e.g., the forward/rearward direction) to connect the electric parts disposed on a front side of the battery pack housing 110 (see FIG. 3) and the electric parts that is disposed on a rear side of the battery pack housing 110.

The upper busbar 430 may extend in the second direction (e.g., the forward/rearward direction) to electrically connect the plurality of battery modules 200 that are spaced apart from each other in the second direction (e.g., the forward/rearward direction) that is a longitudinal direction. A length of the upper busbar 430 in the second direction (e.g., the forward/rearward direction) may be configured to be smaller than a length of the lower busbar 420 in the second direction (e.g., the forward/rearward direction).

The lower busbar 420 may include a first lower busbar 421, and a second lower busbar 422 that is disposed to be spaced apart from the first lower busbar 421 in the first direction (e.g., the leftward/rightward direction). The first lower busbar 421 and the second lower busbar 422 may be fixed by a first lower bracket 521 and a second lower bracket 522, respectively.

Opposite ends of the first lower busbar 421 and the second lower busbar 422 in the second direction (e.g., the forward/rearward direction) may be fixed by the first lower bracket 521 and the second lower bracket 522, respectively, and the first lower bracket 521 and the second lower bracket 522 may be fixed to the transverse support member 150.

The upper busbar 430 may be disposed on an upper side of the lower busbar 420, and may be spaced apart from the lower busbar 420. The upper busbar 430 may include a first upper busbar 431, and a second upper busbar 432 that is disposed to be spaced apart from the first upper busbar 431 in the first direction (e.g., the leftward/rightward direction). The first upper busbar 431 and the second upper busbar 432 may extend in parallel to each other.

The first upper busbar 431 and the second upper busbar 432 may be fixed by a first upper bracket 531 and a second upper bracket 532, respectively. Opposite ends of the first upper busbar 431 and the second upper busbar 432 in the second direction (e.g., the forward/rearward direction) may be fixed by the first upper bracket 531 and the second upper bracket 532, respectively. The first upper bracket 531 and the second upper bracket 532 may be fixed by the transverse support member 150.

The busbar frame 440 may include a lower busbar frame 450 that supports the lower busbar 420 on a lower side of the lower busbar 420, and an upper busbar frame 460 that is disposed between the lower busbar 420 and the upper busbar 430 to support the upper busbar 430.

The second longitudinal support member 142 may include an opening groove 144 having a shape that is opened toward an upper side. The opening groove 144 may extend in the second direction (e.g., the forward/rearward direction) along the second longitudinal support member 142. The lower busbar 420 and the busbar frame 440 may be inserted into the opening groove 144.

The second longitudinal support member 142 may include a contact part 143 that contacts the base plate 120 (see FIG. 1), and a pair of side support walls 145 that extend upward from opposite ends of the contact part 143 in the first direction (e.g., the leftward/rightward direction). The pair of side support walls 145 may be spaced apart from each other in the first direction (e.g., the leftward/rightward direction) while the opening groove 144 being interposed therebetween, and may extend in the second direction (e.g., the forward/rearward direction).

On each of the pair of side support walls 145, a recess 145a may be formed. In more detail, the recess 145a may be formed on an upper surface of each of the side support walls 145 to be opened toward an upper side of a side support wall 145.

The second longitudinal support member 142 may include a base surface 146 that faces the opening groove 144. The base surface 146 may extend in the second direction in a space between the pair of side support walls 145. A base hole 146a may be formed on the base surface 146. A plurality of base holes 146a may be provided and disposed to be spaced apart from each other in the second direction (e.g., the forward/rearward direction).

The lower busbar frame 450 may be inserted into the opening groove 144. The lower busbar frame 450 may include a lower base wall 451 that is supported by the base surface 146 and supports the lower busbar 420, and a pair of lower cover walls 452 that extend upward from opposite ends of the lower base wall 451 in the first direction (e.g., the leftward/rightward direction).

The pair of lower cover walls 452 are spaced apart from each other in the first direction (e.g., the leftward/rightward direction) to define a lower accommodation groove 453 that is open upward between the pair of lower cover walls 452. The pair of lower cover walls 452 may extend in the second direction (e.g., the forward/rearward direction) such that the lower accommodation groove 453 extends in the second direction (e.g., the forward/rearward direction).

The lower busbar 420 may be accommodated in the lower accommodation groove 453. A pair of lower cover walls 452 may extend in the second direction (e.g., the forward/rearward direction) to cover outsides of the first lower busbar 421 and the second lower busbar 422 while the first lower busbar 421 and the second lower busbar 422 being interposed therebetween.

The lower base wall 451 may connect the pair of lower cover walls 452. The lower busbar frame 450 may include a lower guide rib 454 that protrudes upward from the lower base wall 451.

The lower guide rib 454 may extend in the second direction (e.g., the forward/rearward direction) along the lower base wall 451 between the pair of lower cover walls 452. The lower guide rib 454 may improve a strength of the lower base wall 451 and, at the same time, may guide an area, in which the first lower busbar 421 and the second lower busbar 422 are seated in the lower accommodation groove 453. A height of the lower guide rib 454 in the upward/downward direction may be smaller than a height of a lower cover wall 452 in the upward/downward direction.

The lower busbar frame 450 may include a lower partition wall 455 that extends upward from the lower base wall 451 longer than the lower guide rib 454. The lower partition wall 455 may be provided in an area, in which the lower guide rib 454 is not provided from the lower base wall 451, and may be connected to the lower guide rib 454. In more detail, the lower partition wall 455 may be formed in an intermediate area in the second direction (e.g., the forward/rearward direction) of the lower base wall 451, and the lower guide rib 454 may be provided on a front side or a rear side of a lower partition wall 455.

The lower partition wall 455 may extend between the pair of lower cover walls 452 and in parallel to the pair of lower cover walls 452. A height of the lower partition wall 455 in the upward/downward direction may be configured to be greater than a height of the pair of lower cover walls 452 in the upward/downward direction.

The lower busbar frame 450 may include a fixing protrusion 456 that protrudes downward from the lower base wall 451. The fixing protrusion 456 may be inserted into the base hole 146a of the second longitudinal support member 142, and the lower busbar frame 450 may be inserted into the opening groove 144 and supported by the second longitudinal support member 142 as the fixing protrusion 456 is inserted into the base hole 146a.

The upper busbar frame 460 may be disposed on upper sides of the lower busbar frame 450 and the lower busbar 420, and may be inserted into the opening groove 144 that is a space between the pair of side support walls 145.

The upper busbar frame 460 may include an upper base wall 461 that supports the upper busbar 430, and a pair of upper cover walls 462 that extend upward and downward from opposite ends of the upper base wall 461 in the first direction (e.g., the leftward/rightward direction).

The upper busbar frame 460 may include a first upper accommodation groove 463 and a second upper accommodation groove 467 that are formed by the pair of upper cover walls 462 and upper base walls 461. The first upper accommodation groove 463 may be formed at an upper portion of the upper base wall 461 and may be configured to be open upward. The second upper accommodation groove 467 may be formed at a lower portion of the upper base wall 461, and may be configured to be open downward.

The upper busbar 430 may be inserted into the first upper accommodation groove 463. The lower busbar 420 may be inserted into the second upper accommodation groove 467. The pair of upper cover walls 462 may extend in the second direction (e.g., the forward/rearward direction) to cover the outsides of the first upper busbar 431 and the second upper busbar 432 while the first upper busbar 431 and the second upper busbar 432 being interposed therebetween. The pair of upper cover walls 462 may be supported by the pair of lower cover walls 452.

The upper base wall 461 may connect the pair of upper cover walls 462. The upper base wall 461 may connect the intermediate area of the pair of upper cover walls 462 in the upward/downward direction. In more detail, the upper base wall 461 may connect areas of the pair of upper cover walls 462, which are lower than the intermediate area in the upward/downward direction. A first upper accommodation groove 463 may be formed on an upper side of the upper base wall 461, and a second upper accommodation groove 467 may be formed on a lower side of the upper base wall 461.

The upper busbar frame 460 may include an upper guide rib 464 that protrudes upward or downward from the upper base wall 461. The upper guide rib 464 may extend in the second direction (e.g., the forward/rearward direction) along the upper base wall 461 between the pair of upper cover walls 462. The upper guide rib 464 may include a first upper guide rib 464a that protrudes upward from the upper base wall 461, and a second upper guide rib 464b that protrudes downward from the upper base wall 461.

The first upper guide rib 464a may protrude from the upper base wall 461 toward the first upper accommodation groove 463, and the second upper guide rib 464b may protrude from the upper base wall 461 toward the second upper accommodation groove 467.

The first upper guide rib 464a may improve a strength of the upper base wall 461, and at the same time, may guide an area, in which the first upper busbar 431 and the second upper busbar 432 are seated in the first upper accommodation groove 463. The height of the first upper guide rib 464a in the upward/downward direction may be smaller than the height of an upper cover wall 462 in the upward/downward direction.

The second upper guide rib 464b may improve a strength of the upper base wall 461, and at the same time, the first lower busbar 421 and the second lower busbar 422 may guide an area, in which the first lower busbar 421 and the second lower busbar 422 are accommodated in the second upper accommodation groove 467. A height of the second upper guide rib 464b in the upward and downward direction may be smaller than a height of the pair of upper cover walls 462 in the upward and downward direction.

The upper busbar frame 460 may include an upper partition wall 465 that extends upward from the upper base wall 461 longer than the first upper guide rib 464a. The upper partition wall 465 may be provided in an area, in which the first upper guide rib 464a is not provided from the upper base wall 461. In more detail, the upper partition wall 465 may be formed in an intermediate area of an upper base wall 451 in the second direction (e.g., the forward/rearward direction), and the first upper guide rib 464 may be provided on a front side or a rear side of the upper partition wall 465.

The upper partition wall 465 may extend between the pair of upper cover walls 462 in parallel to the pair of upper cover walls 462. A height of the upper partition wall 465 in the upward/downward direction may be greater than a height of the pair of upper cover walls 462 in the upward/downward direction.

The upper busbar frame 460 includes a hook member 466 that protrudes in opposite directions from each of the pair of upper cover walls 462 and is configured to be inserted into the recess 145a of the second longitudinal support member 142.

A plurality of hook members 466 may be provided and may be disposed to be spaced apart from the pair of upper cover walls 462 in a second direction (e.g., the forward and rearward direction), and may protrude from the pair of upper cover walls 462 in the first direction (e.g., the leftward and rightward direction). The hook members 466 may be seated on the side support wall 145.

According to the above-described structure, when the fixing protrusion 456 of the lower busbar frame 450 is inserted into the base hole 146a of the second longitudinal support member 142, the lower busbar frame 450 is seated in the opening groove 144.

The first lower busbar 421 and the second lower busbar 422 may be inserted into the lower accommodation groove 453 of the lower busbar frame 450. The first lower busbar 421 and the second lower busbar 422 may be covered by the pair of lower cover walls 452 and the side support walls 145 and may be spaced apart from the first and second battery modules 200a and 200b. In this way, even when the lower busbar 420 is provided between the first battery module 200a and the second battery module 200b, a short circuit that may occur between the first and second battery modules 200a and 200b may be prevented.

Furthermore, the first lower busbar 421 and the second lower busbar 422 may be disposed to be spaced apart from each other in the first direction (e.g., the leftward/rightward direction) by the lower guide rib 454 and the lower partition wall 455.

According to this structure, even when the first lower busbar 421 and the second lower busbar 422 are disposed adjacent to each other, a short circuit between the first lower busbar 421 and the second lower busbar 422 may be prevented. In this way, the lower busbar 420 may include a partial area that is inserted into the lower accommodation groove 453 to be inserted into the opening groove 144.

When the pair of upper cover walls 462 are seated on the pair of lower cover walls 452, a partial area of the upper busbar frame 460 may be inserted into the opening groove 144. Then, the hook member 466 of the upper busbar frame 460 may be inserted into the recess 145a of the second longitudinal support member 142 to fix a position of the upper busbar frame 460.

When the upper busbar frame 460 is seated on the second longitudinal support member 142, the second upper guide rib 464b of the upper busbar frame 460 may space the first lower busbar 421 and the second lower busbar 422 apart from each other in the first direction (e.g., the leftward/rightward direction).

The first upper busbar 431 and the second upper busbar 432 may be inserted into the first upper accommodation groove 463. The first upper busbar 431 and the second upper busbar 432 may be covered by the pair of upper cover walls 462, and may be spaced apart from the first and second battery modules 200a and 200b. In this way, even when the upper busbar 430 is provided between the first battery module 200a and the second battery module 200b, a short circuit between the first and second battery modules 200a and 200b may be prevented.

Furthermore, the first upper busbar 431 and the second upper busbar 432 may be accommodated in an interior of the first upper accommodation groove 463, which is a space between the pair of upper cover walls 462. The first upper guide rib 464a and the upper partition wall 465 of the upper busbar frame 460 may space the first upper busbar 431 and the second upper busbar 432 apart from each other in the first direction (e.g., the leftward/rightward direction). According to the structure, it is possible to prevent a short circuit between the first upper busbar 431 and the second upper busbar 432.

In this way, even when the upper busbar 430 is disposed on an upper side of the side support wall 145, a short circuit of the first and second battery modules 200a and 200b may be prevented, and a short circuit between the first upper busbar 431 and the second upper busbars 432 may also be prevented.

According to this technology, because the busbar is disposed between the two adjacent battery modules, a short circuit that may occur in the interior of the battery pack may be prevented.

Furthermore, according to this technology, because the busbar may be supported more stably by the busbar frame, a structural stability of the battery pack may be improved.

In addition, according to this technology, because the first upper busbar and the second upper busbar or the first lower busbar and the second lower busbar may be disposed to be spaced apart from each other, a short circuit between the adjacent busbars may be prevented.

In addition, various effects that may be directly or indirectly recognized through the present disclosure may be provided.

The above description is a simple exemplary description of the technical spirits of the present disclosure, and an ordinary person in the art, to which the present disclosure pertains, may make various corrections and modifications without departing from the essential characteristics of the present disclosure. Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A battery pack comprising:
a first battery module;
a second battery module spaced apart from the first battery module in a first direction;
a base plate configured to support the first battery module and the second battery module;
a support member supported by the base plate, and extending in a second direction crossing the first direction in a space between the first battery module and the second battery module; and
a busbar extending from an upper side of the support member in the second direction through the space between the first battery module and the second battery module.

2. The battery pack of claim 1, further comprising:
a busbar frame configured to support the busbar,
wherein the support member comprises an opening groove having a shape opened toward an upper side, and the busbar frame is inserted into the opening groove.

3. The battery pack of claim 2, wherein the support member comprises:
a pair of side support walls spaced apart from each other in the first direction while the opening groove being interposed therebetween, and extending in the second direction.

4. The battery pack of claim 3, wherein the busbar comprises:
a lower busbar including a partial area inserted into the opening groove; and
an upper busbar disposed on an upper side of the pair of side support walls.

5. The battery pack of claim 4, wherein the busbar frame comprises:
a lower busbar frame configured to support the lower busbar on a lower side of the lower busbar and inserted into the opening groove; and
an upper busbar frame disposed between the lower busbar and the upper busbar and configured to support the upper busbar.

6. The battery pack of claim 5, wherein the lower busbar comprises:
a first lower busbar; and
a second lower busbar disposed to be spaced apart from the first lower busbar in the first direction, and
wherein the lower busbar frame includes a lower cover wall extending in the second direction to cover outer sides of the first lower busbar and the second lower busbar while the first lower busbar and the second lower busbar being interposed therebetween.

7. The battery pack of claim 6, wherein the lower busbar frame comprises:
a lower base wall connecting the pair of lower cover wall; and
a lower guide rib protruding upward from the lower base wall.

8. The battery pack of claim 7, wherein a height of the lower guide rib in an upward and downward direction is configured to be smaller than a height of the lower cover wall in the upward and downward direction.

9. The battery pack of claim 7, wherein the lower busbar frame comprises:
a lower partition wall extending from the lower base wall toward an upper side to be longer than the lower guide rib.

10. The battery pack of claim 9, wherein the lower partition wall extends in parallel to the pair of lower cover walls.

11. The battery pack of claim 6, wherein the upper busbar comprises:
a first upper busbar; and
a second upper busbar disposed to be spaced apart from the first upper busbar in the first direction, and
wherein the upper busbar frame includes a pair of upper cover walls covering outer sides of the first upper busbar and the second upper busbar while the first upper busbar and the second upper busbar being interposed therebetween, and supported by the lower cover wall to extend in the second direction.

12. The battery pack of claim 11, wherein the upper busbar frame comprises:
an upper base wall connecting the pair of upper cover walls; and
an upper guide rib protruding upward or downward from the upper base wall.

13. The battery pack of claim 12, wherein the upper guide rib comprises:
a first upper guide rib protruding upward from the upper base wall; and
a second upper guide rib protruding downward from the upper base wall.

14. The battery pack of claim 13, wherein heights of the first upper guide rib and the second upper guide rib in an upward and downward direction are configured to be smaller than a height of the upper cover wall in the upward and downward direction.

15. The battery pack of claim 13, wherein the upper busbar frame comprises:
an upper partition wall extending from the upper base wall toward an upper side to be longer than the upper guide rib.

16. The battery pack of claim 15, wherein the upper partition wall extends in parallel to the pair of upper cover walls.

17. The battery pack of claim 5, wherein a recess is formed in each of the pair of side support walls, and
wherein the upper busbar frame includes a hook member seated on each of the pair of side support walls and configured to be inserted into the recess.
